(19) United States
(12) Patent Application Publication
(10) Pub. No.: US 2015/0148961 A1
(43) Pub. Date: May 28, 2015

(54) BUILDING DATA MANAGING APPARATUS AND BUILDING MANAGEMENT SYSTEM COMPRISING THEREOF

(71) Applicant: Electronics and Telecommunications Research Institute, Daejon (KR)

(72) Inventors: Jong Won KIM, Daejeon (KR); Youn Kwae JEONG, Daejeon (KR); Il Woo LEE, Daejeon (KR)

(73) Assignee: Electronics and Telecommunications Research Institute, Daejeon (KR)

(21) Appl. No.: 14/184,210

(22) Filed: Feb. 19, 2014

(30) Foreign Application Priority Data
Nov. 27, 2013 (KR) 10-2013-0145113

(51) Int. Cl. G05B 15/02; H04L 12/28

(52) U.S. Cl. CPC G05B 15/02; H04L 12/2803
USPC 700/275

(57) ABSTRACT

A building data managing apparatus according to an embodiment of present invention, includes a first processing unit for receiving from equipments within a building a first management data having BACnet protocol and a second management data having wireless communication protocol via the Ethernet communication interface, and converting the first management data and the second management data to BAS (Building Automation System) common communication layer data, a second processing unit for converting the BAS common communication layer data to commissioning common communication layer data, and a third processing unit for converting the commissioning common communication layer data to commissioning common communication layer message having protocol for transmission to an external control server.

### CROSS-REFERENCE TO RELATED APPLICATION

This application is based on and claims priority from Korean Patent Application No. 10-2013-0145113, filed on Nov. 27, 2013 in the Korean Intellectual Property Office, the disclosure of which is incorporated herein in its entirety by reference.

### BACKGROUND OF THE INVENTION

1. Field of the Invention

The present invention relates generally to a building data managing apparatus and a building managing system including the building data managing apparatus.

2. Description of the Related Art

As industrial technology is developed, demand for various energy reduction techniques responding to energy crisis and regulation of carbon dioxide emission is increasing. Analyzing energy use at the national level aspect, in an industry section, a transport section and a building section (including commercial/residential) most of the energy is consumed, therefore various techniques for energy reduction especially in the building is being developed and adopted.

Energy reduction techniques of optimum management for BAS (Building Automation System) equipment such as heating and cooling air conditioning system based on cold and heat source, power system, lighting system and so on, is being researched and adopted. Recently, the energy reduction is being achieved by making and adopting optimum management policy according to the condition of building inside and outside at building management aspect and by evaluating energy efficiency periodically, thereby techniques for constantly maintaining energy efficiency have been studied.

### BRIEF SUMMARY OF THE INVENTION

An object of the present invention is to address at least the problems and/or disadvantages and to provide at least the advantages described below. An aspect of the present invention provides a building data managing apparatus and a building management system including the building data managing apparatus for reducing energy consumption of a building by analyzing and optimizing performance of equipments within the building with monitoring each of the equipments within the building.

Technical objects of the present invention are not limited to the above mentioned technical objects, and the different technical objects may be understood clearly by a person skilled in the art from the following description.

According to an aspect of the present invention, a building data managing apparatus includes a first processing unit receiving from equipments within a building a first management data having BACnet protocol and a second management data having wireless communication protocol via the Ethernet communication interface, and converting the first management data and the second management data to BAS (Building Automation System) common communication layer data, a second processing unit converting the BAS common communication layer data to commissioning common communication layer data, and a third processing unit converting the commissioning common communication layer data to commissioning common communication layer message having protocol for transmission to an external control server.

According to an aspect of the present invention, wherein the BAS common communication layer data may include equipment ID and equipment state information.

According to an aspect of the present invention, wherein the first processing unit may includes a first reception queue receiving the first management data, a second reception queue receiving the second management data, and a data combination unit generating the BAS common communication layer data by combining the first management data and the second management data.

According to an aspect of the present invention, wherein the BAS common communication layer data may have a form adapted to TCP/IP socket communication.

According to an aspect of the present invention, wherein the second processing unit may includes a data analysis unit obtaining the equipment ID by analyzing the BAS common communication layer data, a decision unit deciding whether the equipment ID is same to a predetermined ID, transmitting equipment composition information corresponding to the equipment ID if the equipment ID is same to the predetermined ID, and transmitting a warning message if the equipment ID is not same to the predetermined ID, and a data generation unit generating the commissioning common communication layer data using the BAS common communication layer data and the equipment composition information.

According to an aspect of the present invention, wherein the commissioning common communication layer data may include the equipment ID, the equipment state information and the equipment composition information.

According to an aspect of the present invention, wherein the equipment composition information may include equipment location information, equipment time information and protocol information of the BAS common communication layer data.

According to an aspect of the present invention, wherein the third processing unit may include a commissioning data reception unit receiving the commissioning common communication layer data, an user inquiry processing unit obtaining equipment state information corresponding to predetermined equipment ID based on inquiry command input from an user, an user authentication unit authenticating the user based on the user information transmitted from the user inquiry processing unit, and generating user security level information according to the authentication result, an information processing unit obtaining the equipment state information corresponding to the predetermined equipment ID transmitted from the user inquiry processing unit according to the user security level information and transmitting the equipment state information to the user inquiry processing unit, and a commissioning message generation unit generating the commissioning common communication layer message having the protocol for transmission to the external control server by processing the commissioning common communication layer data.

According to an aspect of the present invention, wherein the commissioning common communication layer message may have REST (Representational State Transfer) protocol.

According to an aspect of the present invention, the building data managing apparatus may further comprise a commissioning processing unit processing commissioning command transmitted from the external control server by communicating with the external control server.

According to an aspect of the present invention, a building management system includes a building data managing apparatus generating common communication layer message by combining a plurality of management data having different protocols each other being gathered from equipments within a building, and an external control server generating commissioning command for controlling state of the equipments by analyzing the common communication layer message transmitted from the building data managing apparatus, and transmitting the commissioning command to the building data managing apparatus, wherein the building data managing apparatus includes a first processing unit receiving from the equipments a first management data having BACnet protocol and a second management data having wireless communication protocol via the Ethernet communication interface, and converting the first management data and the second management data to BAS (Building Automation System) common communication layer data, a second processing unit converting the BAS common communication layer data to commissioning common communication layer data, and a third processing unit converting the commissioning common communication layer data to commissioning common communication layer message having protocol for transmission to the external control server.

According to an aspect of the present invention, wherein the BAS common communication layer data may have a form adapted to TCP/IP socket communication.

According to an aspect of the present invention, wherein the commissioning common communication layer data may include equipment ID, equipment state information, equipment location information, equipment time information and protocol information of the BAS common communication layer data.

According to an aspect of the present invention, wherein the commissioning common communication layer message may have REST (Representational State Transfer) protocol.

According to an embodiment of the present invention, a building data managing apparatus and a building management system including the building data managing apparatus may reduce energy consumption of a building by analyzing and optimizing performance of equipments within the building with monitoring each of the equipments within the building in real time.

### BRIEF DESCRIPTION OF THE DRAWINGS

The above and other features and advantages of certain embodiments of the present invention will became more apparent from the following detailed description taken in conjunction with the accompanying drawings in which:

FIG. 1 is a block diagram briefly illustrating a building management system, according to an embodiment of the present invention.

FIG. 2 is a block diagram illustrating a building data managing apparatus, according to an embodiment of the present invention.

FIG. 3 is a block diagram illustrating a first processing unit of a building data managing apparatus, according to an embodiment of the present invention.

FIG. 4 is a block diagram illustrating a second processing unit of a building data managing apparatus, according to an embodiment of the present invention.

FIG. 5 is a block diagram illustrating a third processing unit of a building data managing apparatus, according to an embodiment of the present invention.

### DESCRIPTION OF EMBODIMENTS

Hereinafter, some embodiments of the present invention will be described in detail using exemplary drawings. In attaching reference numeral to components of each drawing, it should be noted that same components may have the same reference numeral as much as possible, even though the same components are illustrated in different drawings. Further, in describing embodiments of the present invention, description for relevant well-known composition or function is omitted if it is determined that the description disturbs understanding the embodiments of the present invention.

Further, in describing the components of embodiments of the present invention, the term such as first, second, A, B, (a), (b), etc. may be used. The term is merely for distinguishing the component to other components, and the nature, the order, the sequence, or the like of the relevant component is not limited by the term.

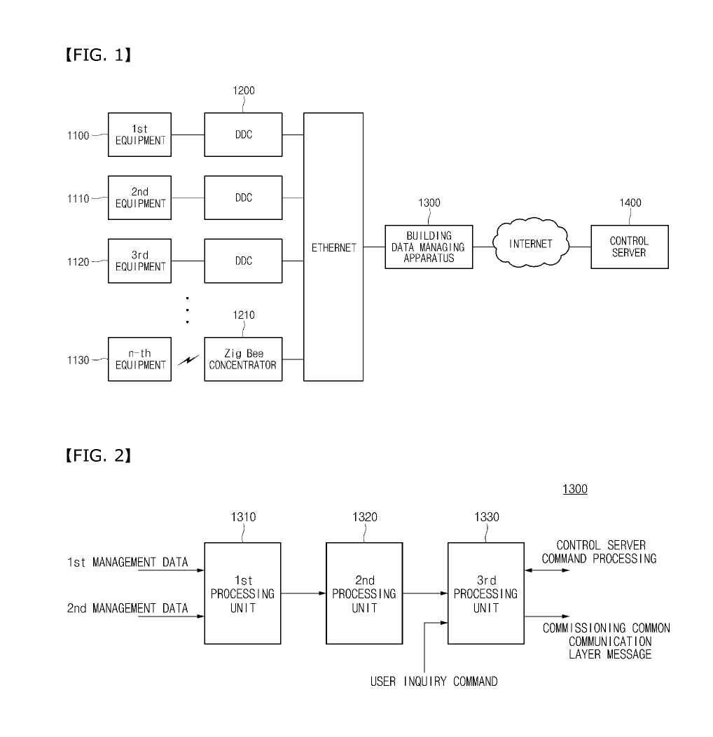

FIG. 1 is a block diagram briefly illustrating a building management system, according to an embodiment of the present invention.

Referring to FIG. 1, the building management system according to an embodiment of the present invention may include equipments 1100, 1110, 1120, 1130 within a building, a direct digital controller 1200, a building data managing apparatus 1300, and control server 1400.

The equipments 1100, 1110, 1120, 1130 may be arranged within one building or a plurality of buildings respectively.

The building management apparatus 1300 may receive management data (called ‘first management data’ in the below) in real time/periodically from sensor attached in, for example, a first equipment 1100 (e.g. cooling equipment), a second equipment 1110 (e.g. heating equipment) and third equipment 1120 (e.g. air conditioning equipment) via the direct digital controller (DDC) 1200. For example, the first management data may have BACnet (Building Automation and Control network) protocol. BACnet may be defined as an international standard of communication scheme related to building automation.

Further, the building data managing apparatus 1300 may receive management data (called ‘second management data’ in the below) in real time/periodically from n-th equipment 1130 (here, n≧4, ‘n’ is natural number) via ZigBee concentrator 1210. In other words, the second management data may have ZigBee communication protocol. Meanwhile, number of the equipments transmitting the first management data or the second management data is not limited to the above description.

The building data managing apparatus 1300 may receive the first management data from the direct digital controller 1200, and receive the second management data from the ZigBee concentrator 1210 via Ethernet communication interface. In other words, the building data managing apparatus 1300 may gather the first management data and the second management data in real time from each of the equipments 1100, 1110, 1120, 1130, and generate commissioning common communication layer message having common communication layer by combining the first management data and the second management data. The building data managing apparatus 1300 may transmit the generated commissioning common communication layer message to the control server 1400 via Internet.

The control server 1400 may receive the commissioning common communication layer message from the building data managing apparatus 1300, analyze it and transmit commissioning command to the building data managing apparatus 1300 according to the analysis result. Concretely, the control server 1400 may recognize equipment state information of each equipment by analyzing the commissioning common communication layer message, and transmit the commissioning command able to control operation state of each equipment to the building data managing apparatus in order to optimize performance of each equipment or reduce energy consumption of the building.

Therefore, the building management system 1000 may reduce energy consumption of the building by analyzing and optimizing performance of each of the equipments within the building with monitoring each of the equipments within the building in real time/periodically.

FIG. 2 is a block diagram illustrating a building data managing apparatus, according to an embodiment of the present invention.

Referring to FIG. 2, the building data managing apparatus 1300 according to an embodiment of the present invention may include a first processing unit 1310, the second processing unit 1320 and the third processing unit 1330.

The first processing unit 1310 may generate BAS (building Automation System) common communication layer data by combining the first management data and the second management data transmitted from equipments 1100, 1110, 1120, 1130 (referring to FIG. 1) in the building. In other words, the first management data and the second management data having different communication protocols each other may be converted to the BAS common communication layer data in order to make have common communication layer.

The BAS common communication layer data may include, for example, equipment ID and equipment state information. The equipment state information may include, for example, temperature, humidity, amount of electricity used of equipment and so on.

The second processing unit 1320 may convert the BAS common communication layer data to commissioning common communication layer data. The commissioning common communication layer data may include, for example, the equipment ID, the equipment state information and equipment composition information, etc. The equipment composition information may include, for example, building information in that equipment is arranged, protocol information of the BAS common communication layer data, location information of equipment within building, time information of equipment, etc.

The third processing unit 1330 may convert the commissioning common communication layer data to the commissioning common communication layer message having protocol for transmitting to the control server 1400. The commissioning common communication layer message may be transmitted to the control server 1400 via Internet. For example, the commissioning common communication layer message may have REST (Representational State Transfer) protocol. Further, the third processing unit 1330 may output by obtaining equipment state information for particular equipment(s) from the commissioning common communication data according to user inquiry command input from user.

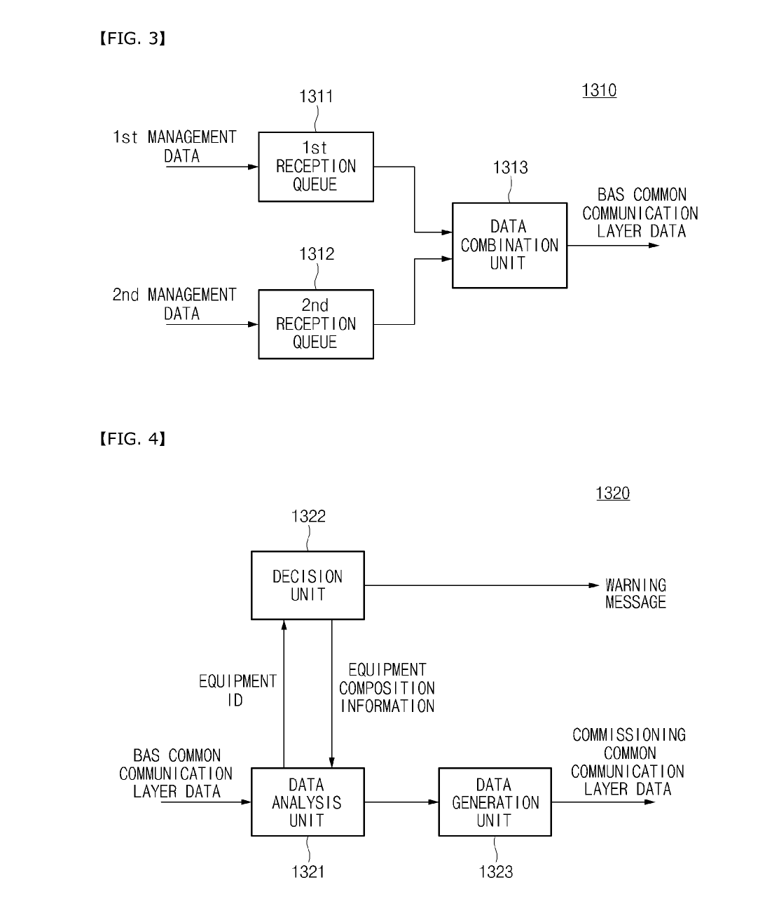

The first processing unit 1310, the second processing unit 1320 and the third processing unit 1330, described in the above, will be explained in detail referring to the below FIG. 3 to FIG. 5.

FIG. 3 is a block diagram illustrating a first processing unit of a building data managing apparatus, according to an embodiment of the present invention.

Referring to FIG. 3, the first processing unit 1310 may include a first reception queue 1311, a second reception queue 1312 and a data combination unit 1313.

The first reception queue 1311 may receive the first management data, and store the received first management data.

The second reception queue 1312 may receive the second management data, and store the received second management data.

Meanwhile, it is illustrated the first reception queue 1311 and the second reception queue 1312 are independent each other in FIG. 3, however, it is not limited to the illustration, and the first reception queue 1311 and the second reception queue 1312 may be implemented as one queue.

The data combination unit 1313 may receive the first management data from the first reception queue 1311, and receive the second management data from the second reception queue 1312. The data combination unit 1313 may generate the BAS common communication layer data by combining the first management data and the second management data. The BAS common communication layer data may have, for example, form adapted to TCP/IP socket communication.

Thus, the first management data may have BACnet protocol and the second management data may have Zig Bee communication protocol. The data combination unit 1313 may generate the BAS common communication layer data to make have common communication layer by combining the first management data and the second management data, therefore, commissioning of the control server 1400 for each of the plurality of the management data may be simple by gathering the plurality of management data having different protocols each other from each of the equipments 1100, 1110, 1120, 1130 (referring to FIG. 1) and transmitting them to the control server 1400.

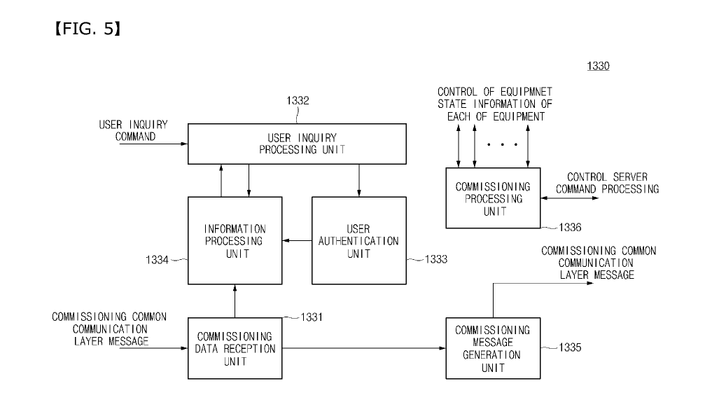

FIG. 4 is a block diagram illustrating a second processing unit of a building data managing apparatus, according to an embodiment of the present invention.

Referring to FIG. 4, the second processing unit according to an embodiment of the present invention may include a data analysis unit 1321, a decision unit 1322 and a data generation unit 1323.

The data analysis unit 1321 may receive the BAS common communication layer data from the first processing unit 1310. The data analysis unit 1321 may obtain equipment ID(s) by analyzing the BAS common communication layer data, and transmit the obtained equipment ID(s) to the decision unit 1322. Further, the data analysis unit 1321 may analyze whether form of the BAS common communication layer data is same to predetermined form.

The decision unit 1322 may decide whether the equipment ID transmitted from the data analysis unit 1321 is same to predetermined ID. It is not illustrated in FIG. 4, the decision unit 1322 may include equipment composition information table comprising equipment composition information. The decision unit 1322 may transmit the equipment composition information corresponding to the equipment ID to the data analysis unit 1321 if the equipment ID transmitted from the data analysis unit 1321 is same to the predetermined ID. Meanwhile, the decision unit 1322 may generate warning message if the equipment ID transmitted from the data analysis unit 1321 is not same to the predetermined ID.

The data generation unit 1323 may generate the commissioning common communication layer data using the BAS common communication layer data and the equipment composition information transmitted from the data analysis unit 1321. In other words, the commissioning common communication layer data may include the equipment ID, the equipment state information and the equipment composition information. The data generation unit 1323 may transmit the generated commissioning common communication layer data to the third processing unit 1330.

Meanwhile, it is not illustrated in FIG. 4, the second processing unit 1320 may further include a warning processing unit for generating warning data using the warning message and transmitting the warning data to the third processing unit 1330.

FIG. 5 is a block diagram illustrating a third processing unit of a building data managing apparatus, according to an embodiment of the present invention.

Referring to FIG. 5, the third processing unit according to an embodiment of the present invention may include a commissioning data reception unit 1331, an user inquiry processing unit 1332, an user authentication unit 1333, an information processing unit 1334, a commissioning message generation unit 1335 and a commissioning processing unit 1336.

The commissioning data reception unit 1331 may receive the commissioning common communication layer data from the second processing unit 1320.

The user inquiry processing unit 1332 may obtain equipment state information corresponding to equipment ID included in inquiry command from the information processing unit 1334 based on the inquiry command input from user. The equipment state information may include, for example, temperature, humidity and amount of electricity used, etc. of equipment.

The user inquiry processing unit 1332 may output the equipment state information corresponding to the equipment ID transmitted from the information processing unit 1334 in order that user may check it.

The user authentication unit 1333 may authenticate user based on user information transmitted from the user inquiry processing unit 1332, and generate user security level information according to the authentication result.

The information processing unit 1334 may obtain equipment state information corresponding to particular equipment ID transmitted from the user inquiry processing unit 1332 from the commissioning common communication layer data according to the user security level information, and transmit the obtained result to user inquiry processing unit 1332. For example, the information processing unit 1334 may transmit inquiry impossibility message to the user inquiry processing unit 1332 if the security level of user is low. Further, for example, the information processing unit 1334 may transmit to the user inquiry processing unit 1332 only a part of the equipment state information (e.g. except for amount of electricity used of equipment) according to the security level of user.

The commissioning message generation unit 1335 may generate the commissioning common communication layer message having protocol for transmitting to the control server 1300 by processing the commissioning common communication layer data. For example, the commissioning message generation unit 1335 may generate the commissioning common communication layer message having REST (Representational State Transfer) protocol. In other words, in one aspect of en embodiment of the present invention, the process of generating the commissioning common communication layer message by the commissioning message generation unit 1335 may be understood like the process of making encapsulation to REST protocol in order to transmit the commissioning common communication layer data to the control server 1400 via Internet.

The commissioning processing unit 1336 may process commissioning command transmitted from the control server 1400 communicating with the control server 1400. For example, the control server 1400 may check the equipment state information of equipment (e.g. 1100) by analyze the commissioning common communication layer message transmitted from the commissioning message generation unit 1335, and transmit the commissioning command able to control operation state of equipment (e.g. 1100) to the commissioning processing unit 1336 in order to optimize performance of equipment (e.g. 1100) or reduce energy consumption of building in that equipment (e.g. 1100) is included. The commissioning processing unit 1336 may control operation state of equipments 1100, 1110, 1120, 1130 (referring to FIG. 1) based on the commissioning command transmitted from the control server 1400.

The above description is just for describing the spirit of the invention by way of examples thereof, modification and changes for the contents described previously may be possible without departing from the spirit and scope of the present invention by one of ordinary skill in the related art in that the present invention is included. Therefore, the described embodiments should be considered in a descriptive sense only and not for purpose of limitation for the spirit of the present invention. The scope of the present invention will be construed by the appended claims, and all the technical spirit within the equivalent scope of the present invention will be construed as being included in the present invention.

What is claimed is:

1. A building data managing apparatus, comprising:
a first processing unit receiving from equipments within a building a first management data having BACnet protocol and a second management data having wireless communication protocol via the Ethernet communication interface, and converting the first management data and the second management data to BAS (Building Automation System) common communication layer data;
a second processing unit converting the BAS common communication layer data to commissioning common communication layer data; and
a third processing unit converting the commissioning common communication layer data to commissioning common communication layer message having protocol for transmission to an external control server.

2. The building data managing apparatus of claim 1, wherein the BAS common communication layer data includes equipment ID and equipment state information.

3. The building data managing apparatus of claim 2, wherein the first processing unit comprises:
a first reception queue receiving the first management data;
a second reception queue receiving the second management data; and
a data combination unit generating the BAS common communication layer data by combining the first management data and the second management data.

4. The building data managing apparatus of claim 3, wherein the BAS common communication layer data has a form adapted to TCP/IP socket communication.

5. The building data managing apparatus of claim 2, wherein the second processing unit comprises:
a data analysis unit obtaining the equipment ID by analyzing the BAS common communication layer data;
a decision unit deciding whether the equipment ID is same to a predetermined ID, transmitting equipment composition information corresponding to the equipment ID if the equipment ID is same to the predetermined ID, and transmitting a warning message if the equipment ID is not same to the predetermined ID; and
a data generation unit generating the commissioning common communication layer data using the BAS common communication layer data and the equipment composition information.

6. The building data managing apparatus of claim 5, wherein the commissioning common communication layer data includes the equipment ID, the equipment state information and the equipment composition information.

7. The building data managing apparatus of claim 6, wherein the equipment composition information includes equipment location information, equipment time information and protocol information of the BAS common communication layer data.

8. The building data managing apparatus of claim 6, wherein the third processing unit comprises:
a commissioning data reception unit receiving the commissioning common communication layer data;
an user inquiry processing unit obtaining equipment state information corresponding to predetermined equipment ID based on inquiry command input from an user;
an user authentication unit authenticating the user based on the user information transmitted from the user inquiry processing unit, and generating user security level information according to the authentication result;
an information processing unit obtaining the equipment state information corresponding to the predetermined equipment ID transmitted from the user inquiry processing unit according to the user security level information and transmitting the equipment state information to the user inquiry processing unit; and
a commissioning message generation unit generating the commissioning common communication layer message having the protocol for transmission to the external control server by processing the commissioning common communication layer data.

9. The building data managing apparatus of claim 8, wherein the commissioning common communication layer message has REST (Representational State Transfer) protocol.

10. The building data managing apparatus of claim 8, further comprising:
a commissioning processing unit processing commissioning command transmitted from the external control server by communicating with the external control server.

11. A building management system, comprising:
a building data managing apparatus generating common communication layer message by combining a plurality of management data having different protocols each other being gathered from equipments within a building; and
an external control server generating commissioning command for controlling state of the equipments by analyzing the common communication layer message transmitted from the building data managing apparatus, and transmitting the commissioning command to the building data managing apparatus,
wherein the building data managing apparatus includes:
a first processing unit receiving from the equipments a first management data having BACnet protocol and a second management data having wireless communication protocol via the Ethernet communication interface, and converting the first management data and the second management data to BAS (Building Automation System) common communication layer data;
a second processing unit converting the BAS common communication layer data to commissioning common communication layer data; and
a third processing unit converting the commissioning common communication layer data to commissioning common communication layer message having protocol for transmission to the external control server.

12. The building management system of claim 11, wherein the BAS common communication layer data has a form adapted to TCP/IP socket communication.

13. The building management system of claim 11, wherein the commissioning common communication layer data includes equipment ID, equipment state information, equipment location information, equipment time information and protocol information of the BAS common communication layer data.

14. The building management system of claim 11, wherein the commissioning common communication layer message has REST (Representational State Transfer) protocol.
